(19) United States
(12) Patent Application Publication
(10) Pub. No.: US 2016/0277713 A1
(43) Pub. Date: Sep. 22, 2016

(54) CONTROLLED LONG-EXPOSURE IMAGING OF A CELESTIAL OBJECT

(71) Applicants: Kamil TAMIOLA, Groningen (NL); Luminita Marilena TOMA, Groningen (NL)

(72) Inventors: Kamil TAMIOLA, Groningen (NL); Luminita Marilena TOMA, Groningen (NL)

(21) Appl. No.: 15/034,488

(22) PCT Filed: Nov. 6, 2014
(86) PCT No.: PCT/EP2014/073968

§ 371 Date: May 4, 2016

(30) Foreign Application Priority Data
Nov. 18, 2013 (EP) 13193355.8

(51) Int. Cl. H04N 7/18; G06T 7/20; G06T 7/60; H04N 5/235

(52) U.S. Cl. CPC H04N 7/18; H04N 5/2353; G06T 7/20; G06T 7/60

(57) ABSTRACT

Some embodiments are directed to a system for enabling an imaging device to perform controlled long-exposure imaging of a celestial object based on the system interrelating an exposure time with a level of object trailing and outputting a result of said interrelating. The interrelating is based on the system estimating an apparent velocity of the celestial object on an imaging sensor of the imaging device. Advantageously, the apparent velocity is accurately and efficiently estimated using the angle of view of the imaging device and the angular velocity of the earth. In addition, latitude data is used to adjust for a relative position of the imaging device to the celestial equator. Compared to the so-termed rule of 500/550/600, the system provides better results in that the long-exposure imaging of a celestial object can be more accurately controlled based on the system's output.

### CROSS REFERENCE TO RELATED APPLICATION

This application is a National Phase filing under 35 C.F.R. §371 of, and claims priority to, International PCT Patent Application No.: PCT/EP2014/073968, filed on Nov. 6, 2014, which claims priority to European Application No.: 13193355.8, filed on Nov. 18, 2013, the contents of each of which are hereby incorporated in their entireties by reference.

### FIELD OF THE INVENTION

The invention relates to a system and a method for enabling an imaging device to perform controlled long-exposure imaging of a celestial object. The invention further relates to an imaging device comprising the system, and to computer program comprising instructions for causing a processor system to perform the method.

### BACKGROUND ART

One of the most important applications of long-exposure photography techniques is the imaging of celestial objects, such as stars, which are visible from earth at night. Such long-exposure imaging typically requires exposure times within the time-scales of seconds to minutes. However, due to the intrinsic rotary motion of the earth, the apparent motion of the celestial object in the night sky is also captured, yielding a blurring of the celestial object in the captured image. This motion blur is also referred to as star trailing or star streaking, and henceforth referred to as object trailing. In most cases of practical interest, object trailing is an undesired aspect of long exposure images, i.e., considered as an imaging artifact. This holds in particular for high-resolution imaging applications where any type of blurring is undesired.

Accordingly, there is a need to enable long-exposure imaging while minimizing or otherwise controlling the level of object trailing in a captured image.

It is known to minimize the level of object trailing in a captured image by using a servo system to track the celestial objects in the night sky. The combination of an imaging device with such a servo system is commonly referred to as a star tracker. Disadvantageously, such star trackers are complex and typically expensive, thereby limiting their use to a select number of professional applications.

It is also known to use semi-empirical rules which interrelate a given focal length with an optimal exposure time. For example, the so-termed “rule of 500”, as explained on the webpage http://starcircleacademy.com/2012/06/600-rule/ at a time of consulting on Feb. 10, 2013 at 12:21, states that the optimal exposure time can be obtained by dividing the number 500 by the effective focal length at which the photograph will be taken. Here, the term ‘optimal exposure time’ refers to a maximal exposure time which limits, i.e., controls, the object trailing to what is considered to be an acceptable level. It is noted that similar semi-empirical rules exist which use the number 550 or 600, i.e., a “rule of 550” or a “rule of 600”. There also exist mobile device applications, i.e., “apps”, which function as long exposure calculator. Based on an analysis of their results, the inventors have recognized these to be based entirely or at least for a substantial part on the aforementioned “rule of 500/550/600”.

### SUMMARY OF THE INVENTION

The inventors have recognized that the rule of 500/550/600 yields sub-optimal results in that the long-exposure imaging of a celestial object can be insufficiently accurately controlled based on application of said rule.

One of the objects of the invention is to obtain a system or method for enabling more accurate control of long-exposure imaging of a celestial object.

The following aspects of the invention enable more accurate control of long-exposure imaging of a celestial object by estimating an apparent velocity of a celestial object on an imaging sensor of the imaging device, interrelating an exposure time with a level of object trailing based on the apparent velocity, and outputting a result of said interrelating, e.g., for use in operating or configuring the imaging device.

A first aspect of the invention provides a system for enabling an imaging device to perform controlled long-exposure imaging of a celestial object based on the system interrelating an exposure time with a level of object trailing and outputting a result of said interrelating, the object trailing being an imaging artifact caused by a relative motion between the celestial object and the imaging device during the long-exposure imaging, and the system comprising:

an input for obtaining:

i) device data indicative of an angle of view of the imaging device, and

ii) latitude data indicative of a latitude of the imaging device;
a processor arranged for interrelating an exposure time to a level of object trailing based on an apparent velocity of the celestial object on an imaging sensor of the imaging device, wherein the processor is arranged for:

j) estimating the apparent velocity of the celestial object based on the angle of view of the imaging device and the angular velocity of the earth, and

jj) in estimating the apparent velocity, using the latitude data to adjust for a relative position of the imaging device to the celestial equator; and
an output for outputting a result of said interrelating.

A further aspect of the invention provides a method for enabling an imaging device to perform controlled long-exposure imaging of a celestial object based on the method interrelating an exposure time with a level of object trailing and outputting a result of said interrelating, the object trailing being an imaging artifact caused by a relative motion between the celestial object and the imaging device during the long-exposure imaging, and the method comprising:
obtaining device data indicative of an angle of view of the imaging device and latitude data indicative of a latitude of the imaging device;
interrelating an exposure time to a level of object trailing based on an apparent velocity of the celestial object on an imaging sensor of the imaging device, wherein said interrelating comprises:

i) estimating the apparent velocity of the celestial object based on the angle of view of the imaging device and the angular velocity of the earth, and

ii) in estimating the apparent velocity, using the latitude data to adjust for a relative position of the imaging device to the celestial equator; and
outputting a result of said interrelating.

A further aspect of the invention provides an imaging device comprising the system. A further aspect of the invention provides a computer program comprising instructions for causing a processor system to perform the method.

Optional aspects of the invention are defined in the dependent claims.

The above measures provide an input for obtaining device data indicative of an angle of view of the imaging device. Here, the term ‘angle of view’ refers to the angular extent of a given scene, e.g., the night sky, that is imaged by the imaging device. Such device data may be indicative of the angle of view in that it allows the angle of view to be calculated or selectively retrieved, e.g., from a database. Furthermore, the input is arranged for obtaining latitude data which indicative of a latitude of the imaging device. Here, the term ‘latitude’ refers to the geographical meaning of the term being a coordinate which represents the north-south position of a point on the earth's surface. The latitude data may be indicative of the latitude in that it allows the latitude to be calculated or selectively retrieved, e.g., from a database.

Furthermore, a processor is provided which is arranged for interrelating an exposure time of the imaging device to a level of object trailing in the captured image. Here, the term ‘relating’ refers to the processor being arranged for establishing internal data which allows calculating a level of object trailing for a particular exposure time, and vice versa. For example, the internal data may represent one or more equations having the level of object trailing and the exposure time as internal variables. Accordingly, the level of object trailing for a particular exposure time may be calculated by substituting the internal variable which represents the exposure time by the particular exposure time and solving the one or more equations for the level of object trailing. It will be appreciated that such internal data may also take various other forms, such as, e.g., a suitably filled multi-dimensional look-up table (LUT).

In accordance with the present invention, the processor establishes the internal data by estimating an apparent velocity of the celestial object on an imaging sensor of the imaging device. Here, the term ‘apparent velocity’ refers to the velocity of the celestial object as it appears to the imaging sensor of the imaging device. It will be appreciated that the apparent velocity relates the exposure time to the level of object trailing in that the level of object trailing is typically proportional to the product of the apparent velocity and the exposure time. For example, if the apparent velocity is expressed in pixels per second and the exposure time is expressed in seconds, the product of both yields the level of object trailing in the form of a number of pixels.

The processor estimates the apparent velocity as a function of a number of variables. Firstly, the estimate of apparent velocity is based on the angle of view of the imaging device and the angular velocity of the earth. Here, the term ‘angular velocity of the earth’ refers to the speed with which the earth rotates about its axis, being, when expressed in degrees, 360° in 24 hours or approximately 15°/hour or 0.0042°/s. Furthermore, the estimate of the apparent velocity is based on the latitude of the imaging device, i.e., its approximate north-south position on the earth's surface.

Furthermore, an output is provided for outputting a result of the interrelating. Here, the term ‘result of the interrelating’ refers to a calculated result as obtained by the processor based on the established internal data. For example, the calculated result may be the exposure time, the level of object trailing or other variable which is obtained as a result of the processor interrelating the exposure time to the level of object trailing.

The inventors have recognized that the apparent velocity may be accurately yet efficiently approximated based on the following assumptions. Firstly, the main cause of the relative motion between the celestial object and the imaging device during the long-exposure imaging is the angular velocity of the earth. Accordingly, the angular velocity of the earth may be considered as a relative velocity of the celestial object with respect to the imaging device. Secondly, such a relative velocity of the celestial object can be expressed as an apparent velocity on the imaging sensor of the imaging device by taking into account the angle of view of the imaging device. This enables the apparent velocity to be expressed in terms of the angle of view of the imaging device e.g., as fractions of the angle of view or as related terms such as number of pixels, which in turn allows the object trailing to be expressed in said terms. Thirdly, the relative motion of the celestial object with respect to the imaging device is to be modulated by the relative position between the imaging device and the celestial equator, with the latitude of the imaging device representing this relative position. A reason for this is that the angular velocity of the earth represents the relative motion between celestial objects that line up with the celestial equator and an imaging device positioned at the celestial equator. In order to compensate for the imaging device not being positioned at the celestial equator, this relative motion can be modulated by the angular distance north or south from the celestial equator, i.e., the latitude of the imaging device, as measured along a circle passing through the celestial poles.

The above measures enable more accurate control of long-exposure imaging of a celestial object since the system is enabled to interrelate the exposure time with the level of object trailing based on an accurately yet efficiently approximated apparent velocity of the celestial object on the imaging sensor of the imaging device. The apparent velocity is accurately approximated by taking into account both the angle of view as well as the latitude of the imaging device. In addition, the apparent velocity is efficiently approximated since it does not rely on a servo system to track the celestial object but rather is based on relatively easy to obtain parameters such as the angle of view and the latitude of the imaging device. Compared to the aforementioned rule of 500/550/600, better results are obtained in that the long-exposure imaging of a celestial object can be more accurately controlled based on the system's output.

Optionally, the processor is arranged for calculating the exposure time based on a predetermined level of object trailing, or calculating the level of object trailing based on a predetermined exposure time. Accordingly, the system's ability to interrelate an exposure time with a level of object trailing and outputting a result of said interrelating is used to obtain an exposure time from a predetermined level of object trailing, or vice versa. Here, the exposure time obtained from a predetermined level of object trailing is an exposure time which, when used during the long-exposure imaging of the celestial object, yields the predetermined level of object trailing. Similarly, the level of object trailing obtained from a predetermined exposure time is a level of object trailing which, when the predetermined exposure time is used during the long-exposure imaging of the celestial object, will occur, i.e., be visible, in the acquired image. Advantageously, the system may be used to calculate a maximum exposure time based on a maximum allowable level of object trailing. In other words, it may be determined how long the exposure time may be while still not exceeding the allowable level of object trailing. Since longer exposure times typically provide improved signal-to-noise ratios and thus improved image quality, the system enables the image quality of the images to be maximized given a maximum allowable level of object trailing.

Optionally, the output is part of an interface for enabling a further entity to obtain said calculated exposure time by providing the predetermined level of object trailing, or to obtain said calculated level of object trailing by inputting the predetermined exposure time. Accordingly, an interface is provided which allows the further entity to interact with the system. For example, the interface may enable a user, the imaging device itself or another entity to interact with the system.

Optionally, the interface is a graphical user interface for enabling user interaction with a user. Accordingly, the user is enabled to obtain the calculated exposure time by inputting the predetermined level of object trailing, or to obtain the calculated level of object trailing by inputting the predetermined exposure time. The graphical user interface may be part of, e.g., a web application, a smartphone application, etc. Having interacted with the system through the graphical user interface, the user may then manually configure the imaging device, e.g., by setting the exposure time to the value calculated by the system. Advantageously, it is not needed for the imaging device to be able to directly interact with the system. Effectively, by involving the user, backward compatibility with existing imaging devices is established.

Optionally, the processor is further arranged for, in estimating the apparent velocity, using orientation data to adjust for a relative orientation of the imaging device to the celestial equator. The inventors have recognized that the apparent velocity may be even more accurately estimated by taking into account the relative orientation of the imaging device to the celestial equator. Here, the term ‘relative orientation’ refers to an alignment of the imaging device, indicating, e.g., whether the imaging device points away or rather towards the celestial equator. A reason for this is that the angular velocity of the earth represents the relative motion between celestial objects that line up with the celestial equator and an imaging device positioned at the celestial equator. If the celestial object being imaged is not lined up with the celestial equator, as would be apparent from the relative orientation of the imaging device pointing away from the celestial equator, such misalignment of the celestial object would need to be compensated for. By using orientation data which is indicative of the relative orientation of the imaging device to the celestial equator, the processor is enabled to compensate for said misalignment of the celestial object in the estimating of the apparent velocity. Advantageously, the system is enabled to more accurately calculate an exposure time based on a predetermined level of object trailing, or vice versa.

Optionally, the orientation data is indicative of an inclination angle of the imaging device with respect to the horizon. Such an inclination angle is indicative of the relative orientation of the imaging device to the celestial equator since the latitude of the imaging device and thus its relative position with respect to the celestial equator is known. Advantageously, the inclination angle can be easily measured or input by the user. In this respect, it is noted that when jointly adjusting for the latitude and the inclination angle of the imaging device, it may not be needed to explicitly calculate the relative orientation of the imaging device with respect to the celestial equator.

Optionally, the orientation data is obtained from an orientation sensor associated with the imaging device. An orientation sensor is well suited for providing the orientation data. Various imaging devices such as smartphones or modern cameras already comprise orientation sensors in the form of accelerometers which are arranged for sensing the orientation of the imaging device. Advantageously, by making use of such existing accelerometers, it is not needed to separately measure the orientation of the imaging device or request the user to input said orientation.

Optionally, the processor is arranged for using different orientation data representing different relative orientations of the imaging device to determine the relative orientation at which a maximal exposure time is obtained for a predetermined level of object trailing, or at which a minimal level of object trailing is obtained for a predetermined exposure time. Accordingly, the processor is enabled to calculate at which relative orientation of the imaging device a maximal exposure time is obtained for a predetermined level of object trailing, or at which relative orientation a minimal level of object trailing is obtained for a predetermined exposure time. Advantageously, such a calculated orientation may be communicated to the user, thereby enabling the user to change the relative orientation of the imaging device to said calculated orientation. Advantageously, orientation data representing the actual orientation of the imaging device may be used to guide the user to said calculated orientation.

Optionally, the processor is arranged for jointly adjusting for the relative position and the relative orientation of the imaging device based on the equation cos(|φ−(90°−λ)|) or a mathematical equivalent, with φ representing an inclination angle of the imaging device with respect to the horizon and λ representing the latitude of the imaging device. This equation or any of its mathematical equivalents is well suited for jointly adjusting for the relative position and the relative orientation of the imaging device. In particular, the equation may provide a modulation function with which an initial apparent velocity of the celestial object may be modulated. Here, the term ‘initial apparent velocity’ refers to the apparent velocity as calculated based on the angle of view of the imaging device and the angular velocity of the earth.

Optionally, the latitude data is obtained from one or more of the group of: a location sensor associated with the imaging device, a user input of a geographical coordinate, and a user input of a location or landmark. Location sensors such as Global Positioning System (GPS) sensors or Wi-Fi based location sensors may be used to automatically detect the latitude of the imaging device. The inventors have also recognized that, for the purpose of interrelating an exposure time with a level of object trailing, it is not needed to detect the latitude very accurately. Accordingly, it may suffice if the user indicates an approximate latitude by inputting an approximate geographical coordinate, a nearby location such as a nearby town, or a nearby landmark.

Optionally, the device data is indicative of one or more of the group of: a focal length of the imaging device, a physical dimension of the imaging sensor, an aspect ratio of the imaging sensor, a resolution of the imaging sensor and a type identifier of the imaging device. Such (combinations of) device data may enable the angle of view of the imaging device to be calculated. Accordingly, it is not needed to directly input the angle of view. It is noted that by specifying a type identifier of the imaging device, the angle of view may be looked up, e.g., in a look-up table (LUT).

Optionally, the imaging device is a one of the group of: a standalone camera, a smartphone comprising a camera, and a tablet device comprising a camera.

### BRIEF DESCRIPTION OF THE DRAWINGS

These and other aspects of the invention are apparent from and will be elucidated with reference to the embodiments described hereinafter. In the drawings,

FIG. 1 shows a system for interrelating an exposure time with a level of object trailing and outputting a result of said interrelating to an imaging device in the form of a Smartphone, as well as a user interacting with the Smartphone;

FIG. 2 shows a method for interrelating the exposure time with the level of object trailing and outputting the result of said interrelating;

FIG. 3 shows a computer program for performing the method, the computer program being embodied on a computer readable medium;

FIG. 4 illustrates the system jointly adjusting for a relative location and relative orientation of the imaging device with respect to a celestial equator;

FIG. 5 shows the exposure time varying as a function of the relative location and relative orientation of the imaging device with respect to the celestial equator;

FIG. 6 shows the exposure time varying as a function of the relative location of the imaging device and a focal length of the imaging device;

FIG. 7 shows a graphical user interface for enabling a user to obtain a exposure time based on input of a maximum desired level of object trailing; and

FIG. 8 shows a further graphical user interface.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

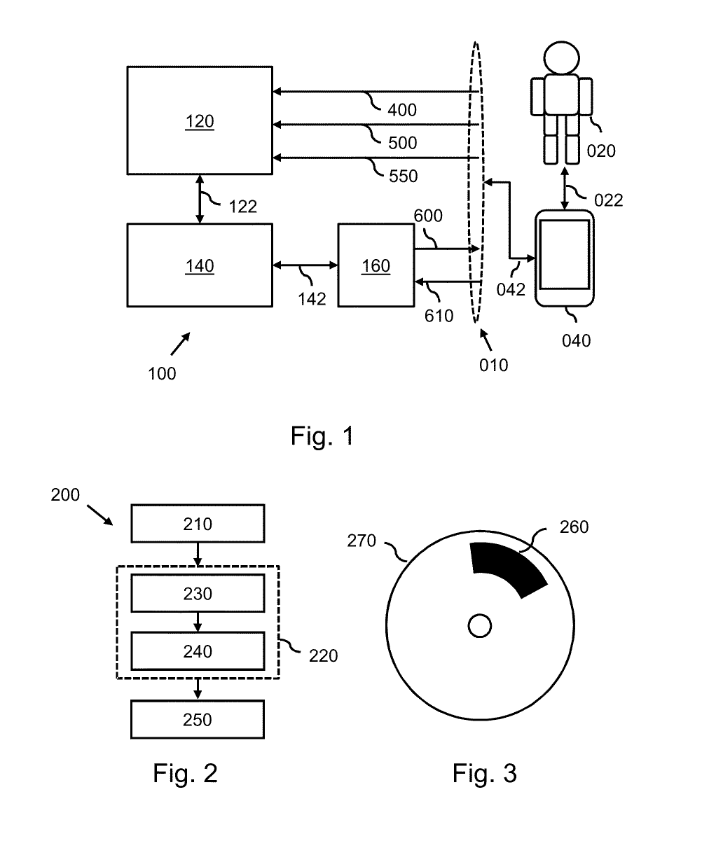

FIG. 1 shows a system 100 for enabling an imaging device to perform controlled long-exposure imaging of a celestial object based on the system interrelating an exposure time with a level of object trailing and outputting a result of said interrelating. By way of example, FIG. 1 shows the imaging device to be a smartphone 040. It will be appreciated, however, that the imaging device may take any other suitable form, such as a standalone compact camera, a standalone Digital Single-lens Reflex (DSR) camera, a tablet device comprising a camera, etc. Furthermore, although FIG. 1 shows the system 100 to be separate from the imaging device 040, the system 100 may also be comprised in, i.e., be part of, the imaging device 040. Alternatively, the system 100 may be comprised in an imaging device such as a smartphone, but may rather be used to enable another imaging device, such as a standalone camera, to perform the controlled long-exposure imaging of the celestial object.

The system 100 comprises an input 120 for obtaining device data 400. The device data 400 may be indicative of an angle of view of the imaging device. Another term for angle of view is field of view. The device data 400 may directly indicate the angle of view, namely by specifying the angle of view. Alternatively or additionally, the device data 400 may be indicative of other parameter(s) which allow the system 100 to calculate or retrieve the angle of view or an equivalent device parameter. Examples of such parameters include a focal length of the imaging device, a physical dimension of the imaging sensor, an aspect ratio of the imaging sensor, a resolution of the imaging sensor and a type identifier of the imaging device. Such parameters may be in part obtained from, e.g., metadata of images acquired by the imaging device 040 such as EXchangeable Image File format (EXIF) metadata, a manual user input, etc.

The input 120 is further arranged for obtaining latitude data 500. The latitude data 500 may be indicative of a latitude of the imaging device 040. For example, the latitude data 500 may be obtained from a location sensor associated with the imaging device, such as an Global Positioning System (GPS) sensor, a user input of a geographical coordinate, or a user input of a location or landmark.

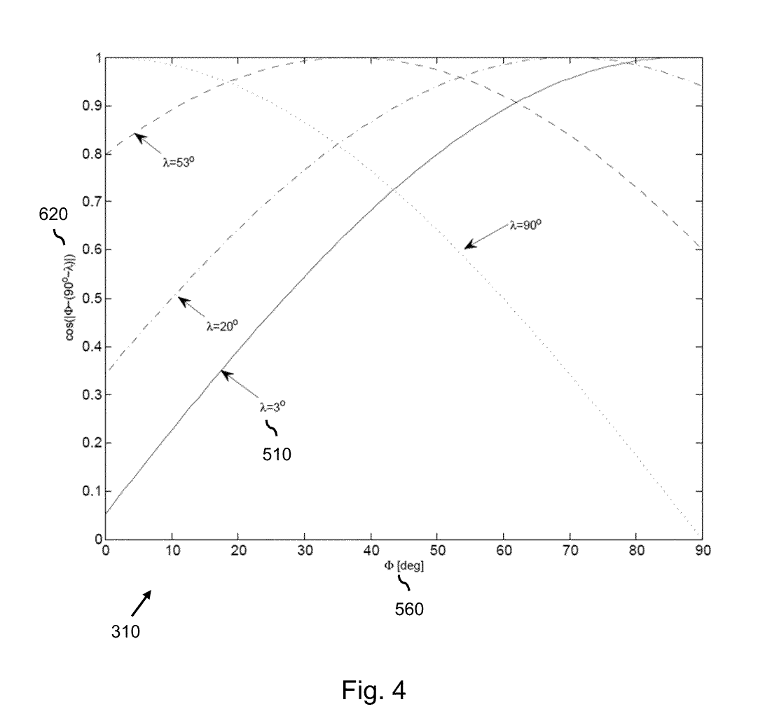

FIG. 1 further shows an optional aspect of the present invention, in that the input 120 may be arranged for obtaining orientation data 550 indicative of a relative orientation of the imaging device 040 to the celestial equator. It is noted that this optional aspect will be further described with reference to FIG. 4 and further.

The system 100 further comprises a processor 140 for interrelating an exposure time to a level of object trailing based on an apparent velocity of the celestial object on an imaging sensor of the imaging device. The processor 140 is arranged for estimating the apparent velocity of the celestial object based on the angle of view of the imaging device and the angular velocity of the earth. Furthermore, when estimating the apparent velocity, the processor 140 uses the latitude data 500 to adjust for, i.e., to compensate for, a relative position of the imaging device to the celestial equator.

To obtain the angle of view and the latitude data 500, the processor 140 is shown to communicate with the input 120, e.g., via an exchange of messages 122.

The system 100 further comprises an output 160 for outputting a result of said interrelating. It will be appreciated that various options exists for said outputting. For example, the processor may calculate an exposure time 600 based on a predetermined level of object trailing 610, or calculate the level of object trailing based on a predetermined exposure time. In the former case, the output 160 may output the exposure time 600, whereas in the latter case, the output 160 may output the level of object trailing. Such output may be in the form of appropriately formatted data.

In the example of FIG. 1, the output is shown to be constituted an interface 160 for enabling a further entity to obtain the calculated exposure time 600 by providing the predetermined level of object trailing 610, or to obtain the calculated level of object trailing by inputting the predetermined exposure time. In the former case, the predetermined level of object trailing 610 may constitute an input to the processor 140 whereas the exposure time 600 may constitute an output, whereas in the latter case, the exposure time 600 may constitute an input to the processor 140 whereas the predetermined level of object trailing 610 may constitute an output. The further entity may be another device such as, e.g., the imaging device 040. The interface 160 may also be an internal interface, e.g., in case the system 100 is comprised in the imaging device 040. The further entity may also be the user 020. For example, the interface 160 may be a graphical user interface for enabling user interaction with the user 020. In accordance therewith, FIG. 1 shows the user 020 interacting with the system 100 by providing user input 022 to the smartphone 040 and the smartphone 040 in turn communicating with the system 100 via an exchange of messages 042.

It is noted that the system 100 may obtain its input and provide its output to different (types of) entities, as will be described with reference to FIG. 4 and further. FIG. 1 accounts for this variety by placing the origin of the input data 400, 500, 550, 610 and the destination of the output data 600 in an abstract circle 010.

An operation of the system 100 may be briefly explained as follows.

The system 100 obtains the device data 400 and the latitude data 500 via the input 120. The processor 140 interrelates the exposure time 600 to the level of object trailing 610 based on the apparent velocity of the celestial object on the imaging sensor of the imaging device. The processor 140 estimates said apparent velocity based on the angle of view of the imaging device and the angular velocity of the earth, and herein uses the latitude data 500 to adjust for a relative position of the imaging device to the celestial equator. Finally, the output 160 outputs a result of said interrelating, e.g., the exposure time 600 or the level of object trailing 610.

FIG. 2 shows a method 200 for enabling an imaging device to perform controlled long-exposure imaging of a celestial object based on the method interrelating an exposure time with a level of object trailing and outputting a result of said interrelating. The method 200 may correspond to an operation of the system 100 of FIG. 1. It is noted, however, that the method 200 may also be performed in separation of the system 100 of FIG. 1, e.g., using a different device or system.

The method 200 comprises, in a first step titled “OBTAINING INPUT DATA”, obtaining 210 device data indicative of an angle of view of the imaging device and latitude data indicative of a latitude of the imaging device. The method 200 further comprises, in a second step titled “INTERRELATING EXPOSURE TIME TO LEVEL OF OBJECT TRAILING”, interrelating 220 an exposure time to a level of object trailing based on an apparent velocity of the celestial object on an imaging sensor of the imaging device. As part of the second step 220, the method 200 comprises, in a first intermediate step titled “ESTIMATING THE APPARENT VELOCITY”, estimating 230 the apparent velocity of the celestial object based on the angle of view of the imaging device and the angular velocity of the earth. As a further part of the second step 220, the method 200 comprises, in a second intermediate step titled “ADJUSTING FOR RELATIVE POSITION OF IMAGING DEVICE”, using 240 the latitude data to adjust for a relative position of the imaging device to the celestial equator in the estimating of the apparent velocity. The method 200 further comprises, in a third step titled “OUTPUTTING RESULT”, outputting 250 a result of said interrelating.

It will be appreciated that the above steps may be performed in any suitable order. In particular, the second step 220 and its first and second intermediate steps 230, 240 may be performed simultaneously, i.e., as one calculation. In addition, the method may be performed iteratively, e.g., in case changes in the input data occur.

FIG. 3 shows a computer program 260 comprising instructions for causing a processor system to perform the method of FIG. 2. The computer program 260 may be comprised in a non-transitory manner on a computer readable medium 270, e.g., in the form of as a series of machine readable physical marks and/or as a series of elements having different electrical, e.g., magnetic, or optical properties or values.

The operation of the system of FIG. 1, the method of FIG. 2, and various optional aspects of the system and method, may be further explained as follows.

As aforementioned, the apparent velocity may be estimated based on the angle of view of the imaging device and the angular velocity of the earth. The angle of view may be obtained based on device data describing physical properties of the imaging device, and in particular physical properties of its imaging sensor. For example, the physical properties may include a horizontal pixel count pw, a vertical pixel count ph, a physical sensor width Iw and a physical sensor height Ih. Here, the physical sensor width and height may be expressed in millimeters. Accordingly, a diagonal pixel count p_{diag} and a diagonal of the imaging sensor I_{diag}, as expressed in millimeters, may be computed by means of the following equations:

p_{diag}(p_{w},pₕ)=\sqrt{p_{w}²+pₕ²} Equation 1

I_{diag}(I_{w},I_{wh})=\sqrt{I_{w}²+Iₕ²} Equation 2

In addition, the apparent velocity may be adjusted, e.g., modulated, based on a relative location and relative orientation of the imaging device with respect to the celestial equator. To obtain the relative location, a latitude may be obtained, i.e., λ as expressed in degrees. Furthermore, in accordance with an optional aspect of the present invention, the relative orientation may be obtained, e.g., in the form of the inclination φ of the imaging device with respect to the horizon as expressed in degrees.

The exposure time t, as expressed in seconds, may now be related to the level of object trailing Δ, as expressed in pixels, based on the following equation:

$$t = \frac{Δ}{0.0042 cos ( \vert φ - ( 90 ° - λ ) \vert ) \frac{{p}_{diag}}{2 arctan \frac{{l}_{diag}}{2 f}}} \qquad Equation 3$$

in which 0.0042 represents the angular velocity of the earth as expressed in degrees per second,

$$\frac{{p}_{diag}}{2 arctan \frac{{l}_{diag}}{2 f}}$$

represents the angle of view of the imaging device, and cos(|φ−(90°−λ)|) represents a modulation function varying between 0 and 1 as a function of the latitude λ and the inclination φ. FIG. 4 graphically illustrates this modulation function 620 for different latitudes 510, i.e., λ being 3°, 20°, 53° and 90°, by showing a graph 310 setting out the value of the modulation function 620 along the vertical axis as a function of the inclination 560 along the horizontal axis.

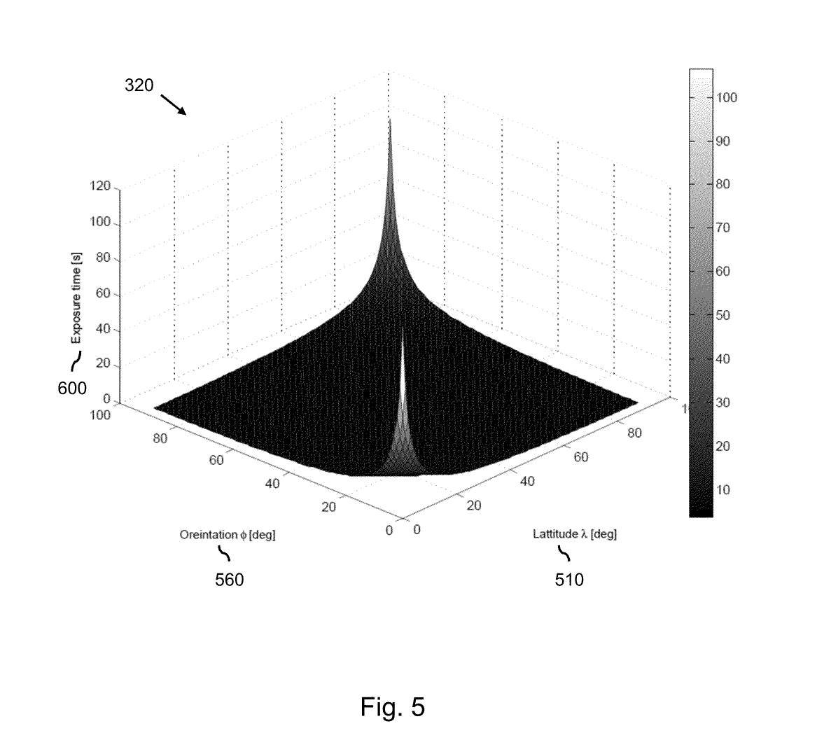

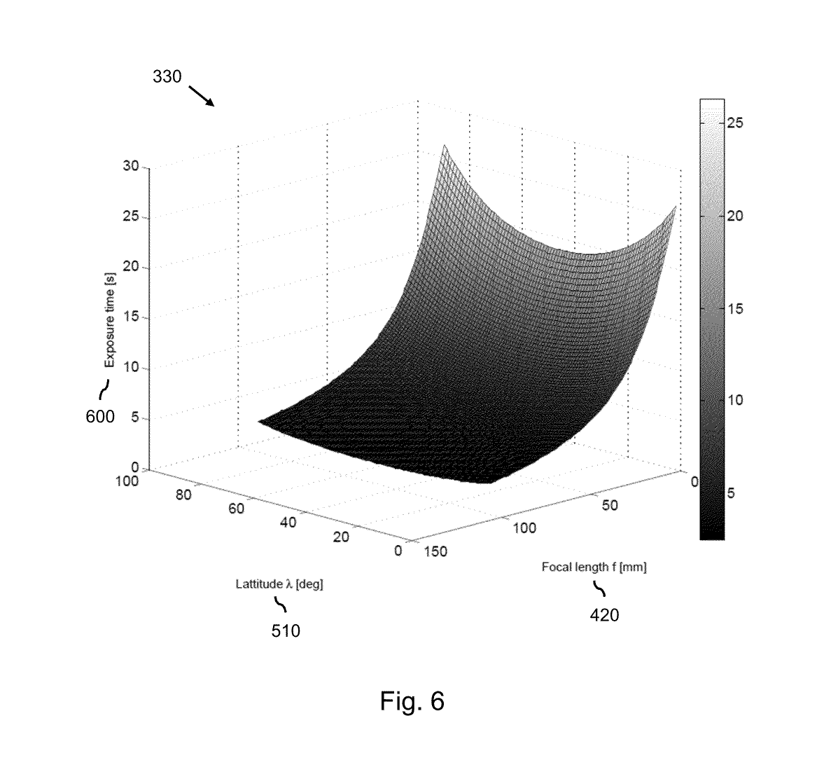

It will be appreciated that the interrelating of exposure time and level of object trailing may be used to calculate the exposure time based on a predetermined level of object trailing and vice versa. Alternatively, equation 3 or its mathematical equivalents also allow determining the inclination φ at which a maximal exposure time can be obtained for a predetermined level of object trailing, or at which a minimal level of object trailing is obtained for a predetermined exposure time. Here, the term ‘predetermined’ refers to the corresponding parameter being considered fixed in the equation, e.g., by being specified by the user. For example, FIG. 5 shows a graph 320 showing the exposure time t as a function of the latitude λ 510 and inclination φ 560 of the imaging device. Given a fixed latitude λ, the inclination φ providing a maximal exposure time t can be easily determined. FIG. 6 shows yet another possibility of the interrelating of the exposure time and the level of object trailing on the basis of equation 3, namely by showing a graph 330 showing the exposure time t as a function of the latitude λ 510 and focal length f 420 of the imaging device. Accordingly, the exposure time t for a particular latitude λ and focal length f can be easily determined.

It is noted that while equation 3 is well suited for estimating the apparent velocity based on the angle of view of the imaging device and the angular velocity of the earth while adjusting for the relative position and the relative orientation of the imaging device to the celestial equation, other suitable implementations are well within the reach of the skilled person on the basis of the present description. For example, instead of using a cosine function, an approximation thereof may be used. It is also noted that the use of the orientation data, e.g., as obtained from an orientation sensor associated with the imaging device, constitutes an advantageous yet optional aspect of the present invention in that the orientation may be disregarded, i.e., assumed fixed.

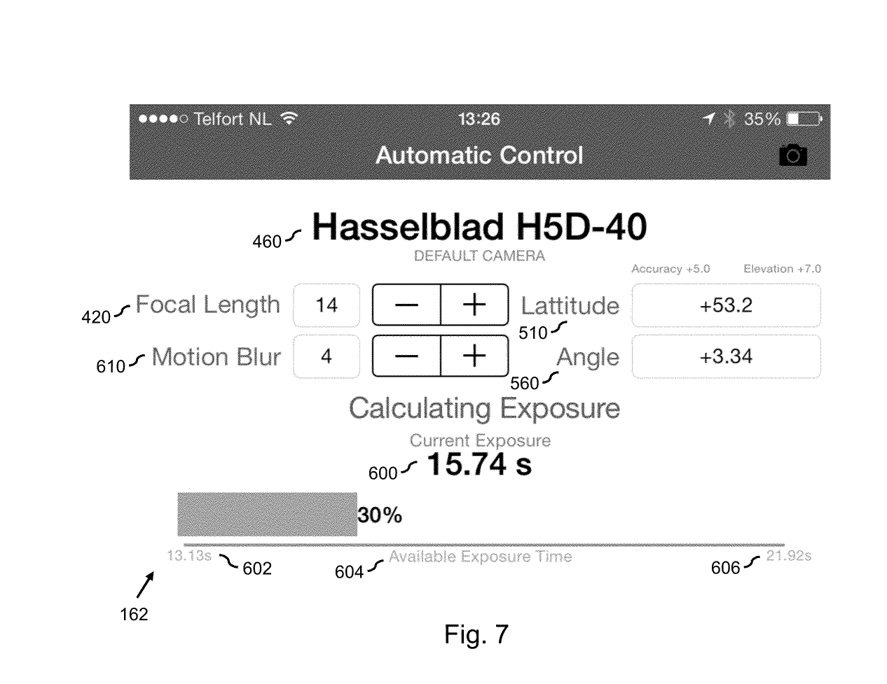

FIG. 7 shows a graphical user interface 162 for enabling a user to obtain a exposure time based on an input of a desired (maximum) level of object trailing. In the example of FIG. 7, the system is implemented as an application for a smartphone, i.e., as a computer program. Accordingly, FIG. 7 shows the graphical user interface 162 of the application. Here, it is shown that the parameters calculated by the application are intended for a different imaging device, i.e., not the smartphone itself but rather a Hasselblad H5D-40. The type of imaging device may have been previously selected by the user, e.g., selecting a type identifier 460 of the imaging device. FIG. 7 shows the graphical user interface 162 enabling the user to specify a value of the focal length 420 and of the motion blur 610. Here, the term ‘motion blur’ refers to the level of object trailing. Accordingly, the user may specify which level of object trailing is to be used for the calculations. Said specified level may typically correspond to a maximum level of object trailing as desired by the user. FIG. 7 further shows the graphical user interface 162 showing the current latitude, i.e., +53.2, and the current angle or inclination, i.e., +3.34. The current latitude may have been obtained from a location sensor of the smartphone. Since the user may use the application while (preparing for the) performing of the long-exposure imaging of the celestial object, the location of the smartphone typically corresponds to that of the imaging device. The current inclination may have been obtained from an inclination sensor of the smartphone. In order for the inclination of the smartphone to correspond to the inclination of the imaging device, the user may be prompted to physically attach, or otherwise align in terms of inclination, the smartphone with the imaging device. Alternatively, the user may be prompted to enter the inclination manually, e.g., by typing in or selecting the inclination.

FIG. 7 further shows the application having calculated an exposure time based on the aforementioned parameters, namely 15.74 s. Said output may be used by the user to manually operate or configure the imaging device, e.g., by entering the exposure time into the imaging device. FIG. 7 further shows the application having determined a range 604 of exposure times which reflect the range of possible inclinations of the imaging device. In particular, FIG. 7 shows that for a certain inclination the exposure time is limited to 13.13 s, thereby establishing a lower limit 602 of the range 604, whereas for another inclination the exposure time may be 21.92 s, i.e. thereby establishing an upper limit 606 of the range 604. Although not show in FIG. 7, the corresponding range of inclinations may be visualized to the user. For example, arrow indicators can be used, with their length and orientation pointing towards the inclinations corresponding to the aforementioned limits 602, 606 of the range 604. This may enable the user to quickly adjust the inclination of the imaging device to obtain the maximal exposure time, e.g., the 21.92 s. Alternatively, a color coding may be used to indicate whether the current inclination is advantageous or disadvantageous.

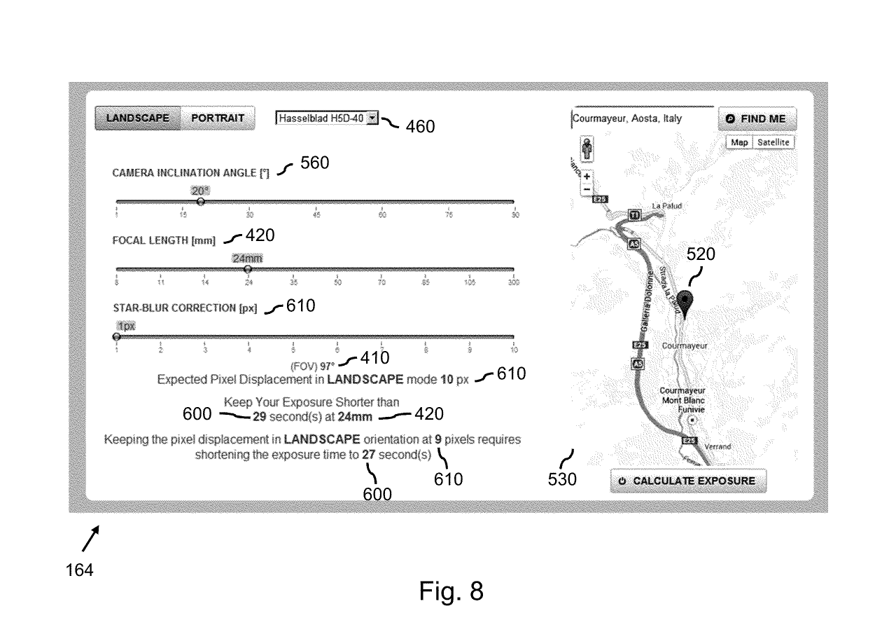

FIG. 8 shows another example of a graphical user interface for enabling a user to obtain an exposure time based on an input of a desired (maximum) level of object trailing. In the example of FIG. 8, the system is implemented as a web-based application, i.e., as a computer program. Accordingly, FIG. 8 shows the graphical user interface 164 of the web-based application. The graphical user interface 164 is shown to enable the user to specify the imaging device, namely by selecting the type identifier 460 of the imaging device, a camera inclination angle 560, a focal length 420 and a star-blur correction 610 as expressed in pixels. Here, the term ‘star-blur correction’ refers to an adjustment of a default level of object trailing, being in this case 10 pixels. Accordingly, the user is enabled to specify a smaller value, e.g., by setting the slider 610 to 1 pixel and thereby indicated a maximum level of object trailing of 9 pixels.

FIG. 8 further shows the angle (or field) of view having been calculated, namely 97°. In addition, the location 520 which is used by the system to obtain the latitude of the imaging device is shown to the user. It is noted that the location may be manually specified by the user, e.g., by typing in a location or landmark in the search box and clicking ‘FIND ME, or by manually repositioning the marker which represents the current location 520 in an onscreen map 530.

FIG. 8 further shows a result of the user having selected ‘CALCULATE EXPOSURE’, namely the web-based application indicating to the user that in order to obtain a maximum pixel displacement of 10 pixels, an exposure time of less than 29 seconds at a focal length of 24 mm is to be used. In addition, the web-based application indicates to the user that in order to limit the pixel displacement to 9 pixels, an exposure time of less than 27 seconds at the same focal length is to be used.

It will be appreciated that the present invention may be used in real-time, i.e., based on a real-time measurement of the latitude and/or inclination of the imaging device. Moreover, it will be appreciated that the present invention may be implemented in the form of an automatic ‘star mode’ for long exposure imaging. This mode may be selectable by the user via, e.g., the program dial of an entry-level imaging device or via an additional menu item in professional-grade imaging equipment. The star mode may offer different computation scenarios, such as i) automatic computation of the longest possible exposure time, ii) automatic computation of the optimal inclination at which an maximum exposure time is obtained for a predetermined level of object trailing, iii) automatic computation of the optimal inclination at which a minimal level of object trailing is obtained for a predetermined exposure time, etc. Here, the optimal inclination may be indicated to the user by providing visual feedback on the real-time measurement of the current inclination of the imaging device. For example, an onscreen indicator may change color when the user changes the inclination of the imaging device, with green indicating the optimal inclination and red indicating a sub-optimal inclination. The present invention may also be implemented as a separate ‘star trail’ mode in which user specifies the star trail length, i.e., the level of object trailing, and the imaging device computes the necessary exposure time. The present invention may also be implemented as an additional feature of a camera application for mobile devices such as smartphones, tablets and other touch controlled devices. The present invention may also be implemented as a standalone, third-party application, available as a downloadable content for mobile devices with imaging capabilities. The present invention may also be implemented as a standalone web-application available from within the web browser, to be used for, e.g., educational and marketing purposes.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for enabling an imaging device to perform controlled long-exposure imaging of a celestial object based on the system interrelating an exposure time with a level of object trailing and outputting a result of said interrelating, the object trailing being an imaging artifact caused by a relative motion between the celestial object and the imaging device during the long-exposure imaging, the system comprising:
an input for obtaining:
i) device data indicative of an angle of view of the imaging device, and
ii) latitude data indicative of a latitude of the imaging device;
a processor arranged for interrelating an exposure time to a level of object trailing interrelating an exposure time to a level of object trailing based on an apparent velocity of the celestial object on an imaging sensor of the imaging device, wherein the processor is arranged for:
j) estimating the apparent velocity of the celestial object based on the angle of view of the imaging device and the angular velocity of the earth, and
jj) in estimating the apparent velocity, using the latitude data to adjust for a relative position of the imaging device to the celestial equator; and
an output for outputting a result of said interrelating.

2. The system according to claim 1, wherein the processor is arranged for calculating the exposure time based on a predetermined level of object trailing, or calculating the level of object trailing based on a predetermined exposure time.

3. The system according to claim 2, wherein the output is part of an interface for enabling a further entity to obtain said calculated exposure time by providing the predetermined level of object trailing, or to obtain said calculated level of object trailing by inputting the predetermined exposure time.

4. The system according to claim 3, wherein the interface is a graphical user interface for enabling user interaction with a user.

5. The system according to 4claim 1, wherein the processor is further arranged for, in estimating the apparent velocity, using orientation data to adjust for a relative orientation of the imaging device to the celestial equator.

6. The system according to claim 5, wherein the orientation data is indicative of an inclination angle of the imaging device with respect to the horizon.

7. The system according to claim 5, wherein the orientation data is obtained from an orientation sensor associated with the imaging device.

8. The system according to claim 5, wherein the processor is arranged for using different orientation data representing different relative orientations of the imaging device to determine the relative orientation at which a maximal exposure time is obtained for a predetermined level of object trailing, or at which a minimal level of object trailing is obtained for a predetermined exposure time.

9. The system according to claim 5, wherein the processor is arranged for jointly adjusting for the relative position and the relative orientation of the imaging device based on the equation cos(|φ−(90°−λ)|) or a mathematical equivalent, with φ representing an inclination angle of the imaging device with respect to the horizon and λ representing the latitude of the imaging device.

10. The system according to claim 1, wherein the latitude data is obtained from one or more of the group of: a location sensor associated with the imaging device, a user input of a geographical coordinate, and a user input of a location or landmark.

11. The system according to claim 1, wherein the device data is indicative of one or more of the group of: a focal length of the imaging device, a physical dimension of the imaging sensor, an aspect ratio of the imaging sensor, a resolution of the imaging sensor and a type identifier of the imaging device.

12. An imaging device comprising the system according to claim 1.

13. The imaging device according to claim 12, wherein the imaging device is a one of the group of: a standalone camera, a smartphone comprising a camera, and a tablet device comprising a camera.

14. A method for enabling an imaging device to perform controlled long-exposure imaging of a celestial object based on the method interrelating an exposure time with a level of object trailing and outputting a result of said interrelating, the object trailing being an imaging artifact caused by a relative motion between the celestial object and the imaging device during the long-exposure imaging, and the method comprising:
obtaining device data indicative of an angle of view of the imaging device and latitude data indicative of a latitude of the imaging device;
interrelating an exposure time to a level of object trailing based on an apparent velocity of the celestial object on an imaging sensor of the imaging device, wherein said interrelating comprises:
i) estimating the apparent velocity of the celestial object based on the angle of view of the imaging device and the angular velocity of the earth, and
ii) in estimating the apparent velocity, using the latitude data to adjust for a relative position of the imaging device to the celestial equator; and
outputting a result of said interrelating.

15. A computer program comprising instructions for causing a processor system to perform the method according to claim 14.

16. A computer program according to claim 15, embodied on a computer readable medium.
